(19) United States
(12) Patent Application Publication
(10) Pub. No.: US 2006/0259586 A1
(43) Pub. Date: Nov. 16, 2006

(54) System and method for collaborating and communicating data over a network

(76) Inventors: Samuel W. Wood, Defiance, MO (US); Patrick O. Schnarr, Waterloo, CA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/345,469

(22) Filed: Feb. 1, 2006

Related U.S. Application Data
(60) Provisional application No. 60/649,032, filed on Feb. 1, 2005.

(51) Int. Cl. G06F 15/16

(52) U.S. Cl. 709/219

(57) ABSTRACT

A system and method for communicating data over a network includes at least one user device and a server communicatively coupled to user device via the network. The server is configured to receive a request from the user device for access to at least one communication module, such as a video conferencing module, a video streaming module, and a document management module, and to deliver a user interface to the user device to enable the user device to access the communication module. Preferably, the least one communication module includes a plurality of communication modules that can be selectively activated or deactivated by the server based on the user's access rights.

### CROSS-REFERENCE TO RELATED APPLICATION

This application claims the priority benefit of U.S. Provisional Patent Application Ser. No. 60/649,032, filed Feb. 1, 2005, the entire scope and content of which is hereby incorporated herein by reference.

### TECHNICAL FIELD

The present invention relates generally to communicating data, and in particular, to a system and method for collaborating and communicating data over a network.

### BACKGROUND OF THE INVENTION

Internet technology allows users to communicate data between each other over a packet-based network (e.g., the Internet) using various communications protocols. For example, many people communicate via email and instant messaging on a daily basis. A communications protocol known as Voice over Internet Protocol (VoIP) enables users to communicate verbally with each other over a packet-based network as if they were talking on the telephone over a circuit-switched network. It is also known to use video conferencing technology to enable users to communicate both verbal and visual content over a network. However, such known systems for communicating data over the Internet typically require the user to download software to the device accessing the Internet and require ports on the user's firewall (assuming the user has a firewall) to be opened to use such services, which can decrease the security of the system and allow unauthorized users to potentially access the data being communicated.

Accordingly, it can be seen that a need exists for securely collaborating and communicating data over a network. It is to such provision that the present invention is primarily directed, which solves the above-described shortcomings and other related and unrelated shortcomings.

### SUMMARY OF THE INVENTION

Generally described, the present invention provides a system for communicating data over a network. In an example embodiment of the invention, the system includes a user device and a server communicatively coupled to the user device via the network. The server is configured to receive a request from the user device for access to at least one communication module and to deliver a user interface to the user device to enable the user device to access the communication module. The user interface and the at least one communication module can be controlled locally on the user device. The communication module can include a plurality of communication modules, such as a video conferencing module, a document management module, and a video-streaming module, for example. Preferably, the server can selectively activate or deactivate each communication module within the user interface based on the user's access rights. The server can further be configured to receive a user document in a first format and to repurpose the user document into a second format, such as a rich media format.

In another example embodiment, the present invention includes a method for communicating data over a network. The method includes the steps of receiving a request from a user device in a remote server for access to at least one communication module and delivering a user interface from the remote server to the user device to enable the user device to access the at least one communication module. The at least one communication module and the user interface can be controlled locally on the user device. Additionally, the method can include the step of synchronizing cache on the server with cache associated with the user interface only when a new event within the user interface occurs. Such new event can include at least one of posting an alert to the system, passing the control of a module to another user, uploading a new document, and requesting use of a different module. Also additionally, the method can include the step of receiving an uploaded document and repurposing the document into an interactive format prior to publishing the document for use. Moreover, the method can include the step of selectively activating the at least communication module based on a user's access rights.

In yet another example embodiment, the present invention includes a user interface that includes at least one button or menu for accessing a communication module or a plurality of communication modules hosted by a remote server, wherein the communication module is controlled locally on a user device. The communication module or modules can include a video conferencing module, a document management module, and/or a video-streaming module. Preferably, the user interface stores cache within the user interface and not on the user device.

In still another example embodiment, the present invention includes a computer program for communicating data over a network. The computer program is embodied on a computer-readable medium and includes instructions for receiving a request from a user device in a remote server for access to at least one communication module and for delivering a user interface to the user device from the remote server, wherein the user interface and the at least one communication module can be controlled locally on the user device. Optionally, the computer program can include instructions for synchronizing cache on the server with cache associated with the user interface only when a new event within the user interface occurs; repurposing an uploaded document prior publishing the document for use; and selectively activating the at least communication module based on a user's access rights.

Accordingly, the present invention provides a system and method for collaborating and communicating data over a network that increases security and user convenience while decreasing the amount of network resources used. The system is secure because the software or code that controls the communication modules of the server are stored on the server, and not on the user's device 12 in cache. Preferably, nothing is left behind on the user device that can later be potentially accessed by an unauthorized user. User convenience is increased because the user can access the user interface with its communication modules from any user device at any time, and all the functionality of the user interface remains consistent across various types of user devices. Also, user convenience is also increased when sharing documents with others within the system. The user simply uploads a document, in any format, to the server, and the server (not the user) repurposes the file into an appropriate format, typically a rich media format, such as that of the ADOBE FLASH PLAYER™ software program.

Moreover, network resources are conserved for a couple of reasons. First, the publishing of documents via the user interface for others to access eliminates the need to email such documents to the others. Emailing documents can trigger a recipient's spam and virus scanning software that typically removes or quarantines the attachments. Also, such emails typically pass through the recipient's email server, which increased bandwidth traffic on the email server. Both of these shortcomings of emailing attachments are obviated by the present invention's system and method for sharing files. Second, by synchronizing the server cache with the cache of the user interface only when a new event has occurred, network resources are conserved because the server and the user interface are not constantly sending and receiving requests and commands between each other. Rather, the synchronization of the cache occurs only when a new event occurs, which in effect changes the cache settings on either the server or the user interface. Thus, by synchronizing the cache only when an event has occurred to change the cache, the server effectively reduces the overall communication traffic by an order of magnitude and improves the security risks associated with sending data by not constantly sending and receiving data.

The specific techniques and structures employed by the invention to improve over the drawbacks of the prior devices and accomplish the advantages described herein will become apparent from the following detailed description of the example embodiments of the invention and the appended drawings and claims.

### BRIEF DESCRIPTION OF THE DRAWINGS

FIG. 1 is a block diagram of a system for collaborating and communicating data over a network according to a first example embodiment of the present invention.

FIGS. 2-4 depict various exemplary screens of a hub interface as generated by the system of FIG. 1.

FIG. 5 is a flow diagram of a method of using the system of FIG. 1.

FIG. 6 is a flow diagram of method of initiating a hub of the system of FIG. 1.

FIG. 7 is a flow diagram of a method of delivering data to a user device via the hub interface of FIGS. 2-4, including synchronizing cache of the user device with cache of the hub.

### DETAILED DESCRIPTION OF EXAMPLE EMBODIMENTS

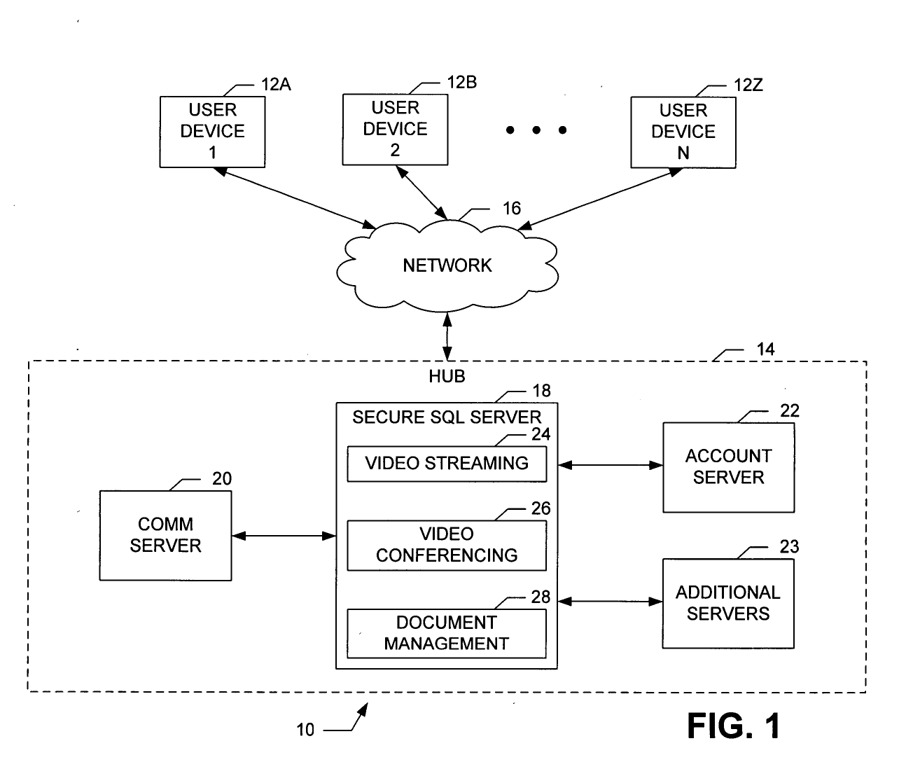

Referring now to the drawing figures, FIG. 1 shows a system 10 for collaborating and communicating data and/or content according to a first example embodiment of the present invention. The system 10 includes a plurality of user devices 12 connected to a remote hub 14 via a network 16. Preferably, the network 16 is the Internet; however, those skilled in the art will understand that in lieu of the Internet 16, the plurality of user devices 12 can be connected to the hub 14 via any network, including, for example, a local area network (LAN) and a wide-area network (WAN). The user devices 12 can include one or more computers such as, for example, personal computers, laptop computers, and handheld computers, or wireless devices, such as cellular telephones and personal digital assistants. Those skilled in the art will understand in view of the description provided herein, that any user device having a network connection can be connected to the hub 14. In the exemplary embodiment, the user device 12 is a personal computer equipped with a webcam and a rich media software application program (e.g., a plug-in), such as the ADOBE FLASH PLAYER™ software program.

The hub 14 includes at least one primary server 18, and preferably a plurality of servers. Preferably, the primary server is a secure SQL server or database 18. The hub 14 may include additional servers, such as, for example, a communication server 20 (which is generally well known in the industry), an account server 22, and a plurality of additional or backup servers 23 in communication with the secure SQL server 18. In an exemplary embodiment, the hub 14 uses Java Remoting or Flash Remoting, both of which are generally well known within the industry, over the protocol RMTP, to establish connections or handshakes between servers within the secure domain of the hub.

The secure SQL server 18 provides a secure persistent connection to the user device 12 for the streaming of data, including video and audio data as well as files such as word processing documents, spreadsheets, and pictures and images. The SQL server 18 hosts and controls various modules, applications, and functions (sometimes collectively referred to herein as “modules” or “communication modules”) for collaborating and communicating data, such as a video streaming module 24, a video conferencing module 26, and a document management module 28. Regarding the document management module 28, the hub 14 repurposes uploaded documents (of any format) into interactive files, such as flash files or other rich media files, prior to publishing the document so that other users of the system 10 can use (e.g., view and edit) the document. The repurposed files can be utilized by any of the communication modules of the hub 14.

The account server 22 stores a user's account information in a user account string. Such account information in the string may include, for example, the user's personal information, company or group information, agent information, and product identification. The user's personal information typically includes information specific to the particular user, such as the user's name, login information, address, email address, phone number, and any other information particular to the user. Company or group information typically includes information particular to the company, including the company name, address, phone number, and payment information. Payment information typically identifies features or modules of the hub that the company has selected and paid for, as well as the method of payment. In an exemplary embodiment, a company or group will pay for certain features or modules of the hub so that all or a select subset of its employees will be able to access such features or modules. Thus, only the selected or paid for features and modules are activated for the user's account. Preferably, the users of the system 10 are segmented into company or group codes for keeping the files and access rights separate for separate companies or groups. Thus, the users of Group A cannot access the files or data of the users of Group B. Additionally, the account server 22 can also include a payment processor and an administration module for tracking reports and profiles of users and groups of users and for modifying profiles of users and groups of users.

Agent information typically includes information relating to the manager of the Group, but can include various other information as well. Product identification typically includes the information regarding the specific modules that the user has rights to use. Each module or function of the hub interface 30 has a code associated therewith. The codes for the modules that user chooses to access (and hence pays for) are included in the string of information so that the hub 14 can access the information to determine which modules and functions to selectively activate. Thus, the user account information, including the login information, is associated with the user's access rights to specific modules and specific files.

Prior to first using the hub 14, new users (or their representatives) would set up an account on the account server. Such user account would typically be a user account within a corporate or group account (so that data of the group can be shared with others in the group). The user or representative would typically select which modules they want to be able to access, or to allow their employees to access, and would input all of their information, including the information pertaining to the individual user, group, agent, and product identification, into the account server 22. The hub 14 uses the user account string of information to selectively activate or deactivate certain modules and features of the hub interface (based on the product identification information) and to allow user access to certain files (based on the company or group information).

Preferably, the hub 14 manages load balancing of the various user and group accounts that are active within the system 10 at any given time. Thus, the hub 14 manages load balancing when the users request use of a module or modules for conferencing or communications. The load balancing is accomplished by identifying the unique user account string in the database/server 18 and comparing the string to the current modules in progress. To balance the load across the servers of the hub 14, the server 18 then may refer the user requests to one of the plurality of servers 23 having capacity, which is preferably located within the same security domain access settings as the server 18.

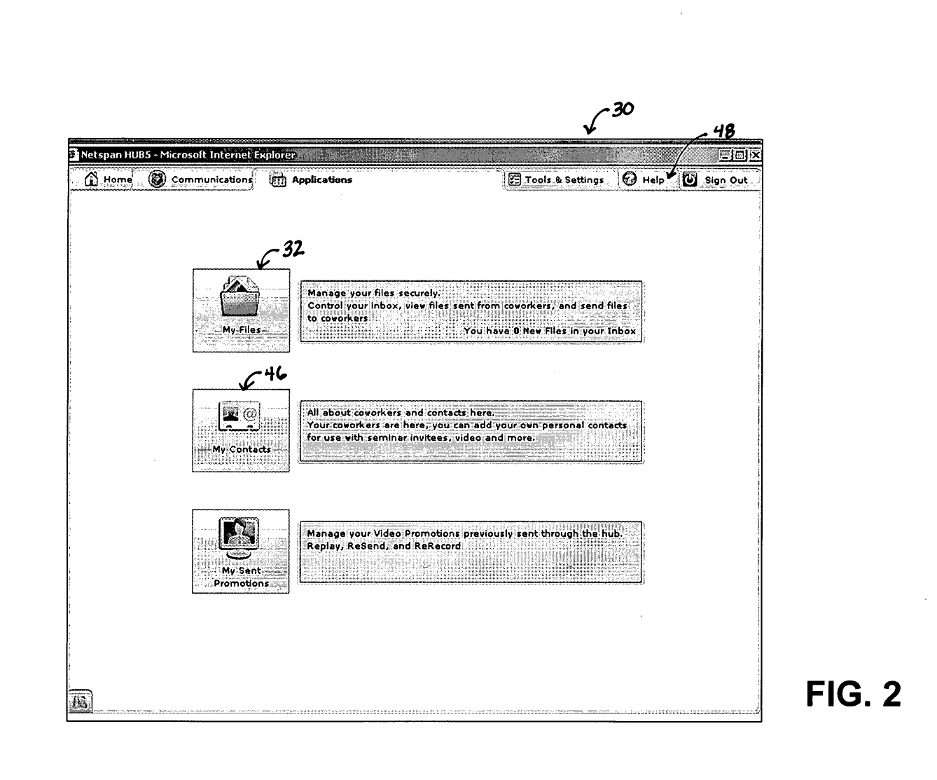

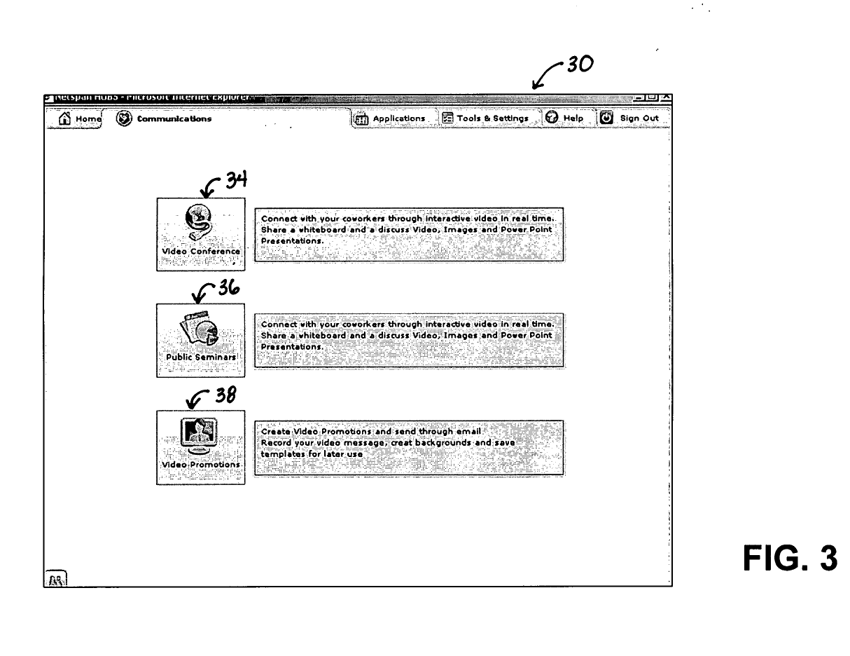

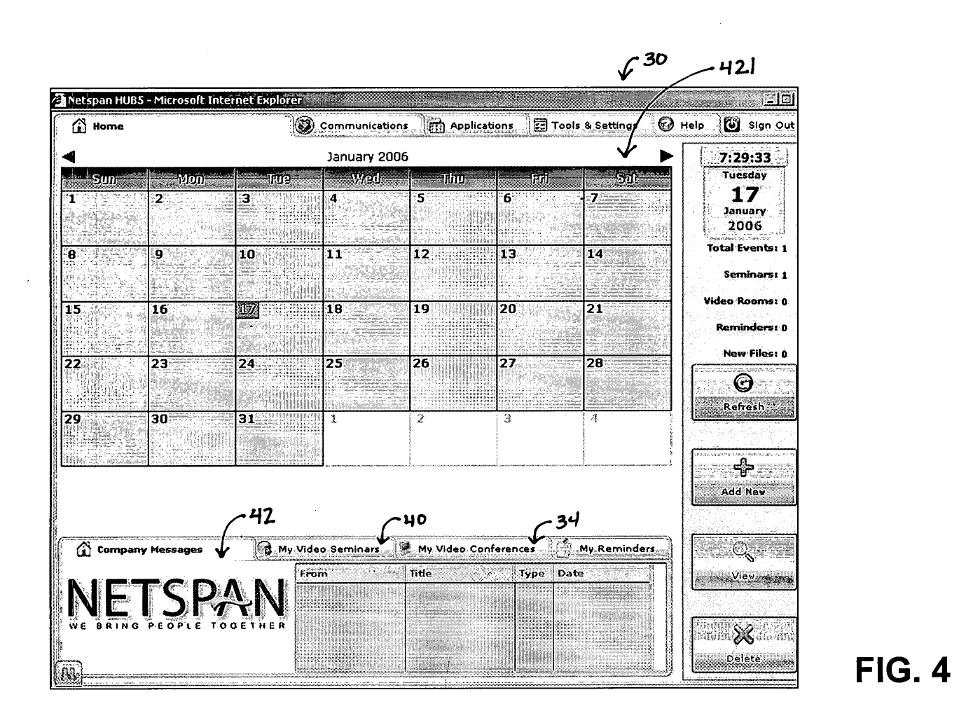

The hub 14 provides a persistent secure connection to the user device 12 and streams data to the user device via a hub interface 30. FIGS. 2-4 depict various exemplary screens of the hub interface 30 as delivered to the user device 12. Those skilled in the art will understand that in view of the description provided herein, the screens of FIGS. 2-4 are merely exemplary and that other screens in other formats may be used to accomplish the functions of the present invention. The hub interface 30 preferably includes applications or modules for document management such as file sharing (or “MyFiles”) 32, video conferences 34, public seminars 36, video promotions 38, video seminars 40, and email or messages 42. Those skilled in the art will appreciate that the general concepts of video conferences, promotions, and seminars, as well as email, are generally well known. The interface 30 also includes features such as, but not limited to, a calendar 44, a contacts list 46, a help screen 48, and a whiteboard (not shown). The contacts list 46 allows the user to send email messages to contacts in the contacts list, to instant message contacts in the contacts list, and to invite contacts in the contacts list to participate in video seminars and video conferences. The hub interface 30 preferably includes one or more buttons and/or menus for selecting one or more applications or modules. Thus, the user controls or uses the hub interface 30, and its associated functions, locally on the user device 12, which is unlike typical conventional interfaces that allow a user to remotely control a computer desktop from another device.

File sharing 32 includes uploading documents to the hub 14 so that other users within the system 10 can access those documents. File sharing can also include posting documents to the video conferences and video seminars (such as with the use of a whiteboard). Files of any form (e.g., word processing, spreadsheets, slides, images, and pictures) can be shared, but preferably the files are repurposed into another form. For example, word processing documents, spreadsheets, slide shows, pictures or images, and any other type of data files are typically repurposed into a flash file or other rich media file that others can view and edit using a flash player, such as the ADOBE FLASH PLAYER™ software program, for example. A user may even “drag and drop” an item from a website, such as a GOOGLE™ map, or from its desktop into the whiteboard, and the hub 14 will repurpose the file into a flash file without intervention by the user.

When a user uploads a document to the SQL server/database 18, the hub 14 parses the content for indexing and conversion. For example, if a user uploads a MICROSOFT® POWERPOINT file to the hub 14 for storage and sharing, the file is first converted for repurposing as a flash file using conventional repurposing techniques. Those skilled in the art will understand how to repurpose a file from one format into another format. Preferably, the file is processed and repurposed on the hub 14, and not on the user device 12. Thus, a user can simply upload the document in its native format, without converting it to another format, to the hub 14 via the user interface 30. Once the file is processed on the hub 14, it can be used in any of the modules, such as in the video conference module 34 or video promotions module 38 to present the content of the file to other users in the group. If the file is stored to the file sharing module 32 (or “MyFiles” module as shown in the figures), then a notification is sent to all other users of the group that the file is available for viewing and even editing. Because files can be easily shared with others within the system 10, there is no need to email documents as attachments to others, which avoids spam and virus scanning software that typically removes or quarantines the attachments. Sharing files, as compared with emailing files as attachments, also saves the bandwidth traffic of the attached files from passing through the user's email server. Furthermore, the user can download the previously repurposed file to the user device 12 in the file's native format (i.e., the format in which the document was uploaded to the hub 14).

In an exemplary embodiment, the hub 14 stores and retrieves data in a markup language format, such as XML (extensible Markup Language). Preferably, XML is used because of its ability to define data formats in such a way to define complex structures, typically referred to as schema. The XML schema allow the hub 14 to parse the user requests, such as for access to any module, and to build as the platform for repurposing of the content. Advantageously, the use of XML allows for the ability to define the schema of all of the text, graphics, and object's locations within the user views of the hub, which thus allows for easier localization of languages and control of the system.

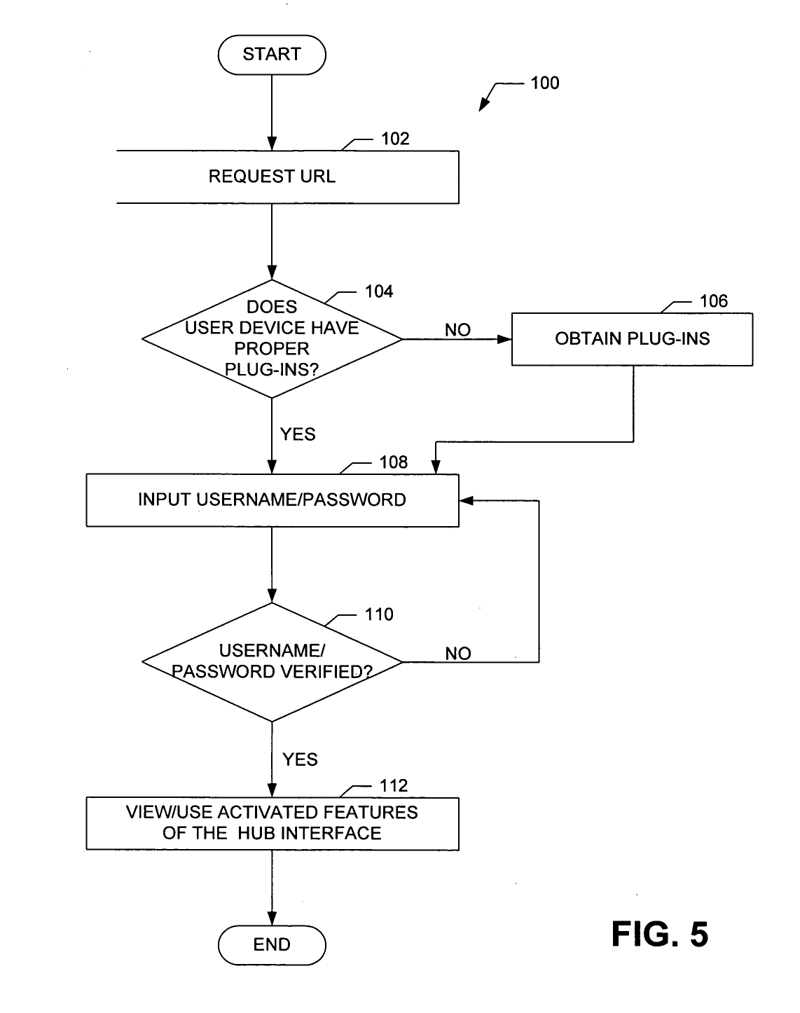

Referring now to FIG. 5, a method 100 of using the system 10 is described from the perspective of a user thereof. Beginning at step 102, the user opens a web browser and accesses a uniform resource locator (URL), which is the global address of the hub 14. At step 104, a determination is made as to whether or not the user device 12 has the proper software or rich media plug-ins, such as a plug-in for flash technology. If the user device 12 does not have the proper software, then at step 106, the user receives a message to obtain the proper plug-ins and obtains the proper plug-ins. Optionally, the message notifying the user that certain plug-ins have not been installed may include a link to a website that has the software available for downloading. The user can then download and install the appropriate software. In the exemplary embodiment, the appropriate software program is the ADOBE FLASH PLAYER™ software program.

Once the appropriate software is installed on the user device 12, the method 100 proceeds to step 108 where the user inputs his or her username and password, or other login information, into a login screen. A determination is made at step 110 as to whether or not the username and password can be verified. If the username and password cannot be verified, then the user receives an error message, and the method 100 loops back to step 108 so that the user can then input a correct username and password. Once the username and password are verified, the method 100 proceeds to step 112 where the user can view and use the activated features or modules of the hub interface 30.

The activated modules can be all of the modules of the hub 14, or the activated modules can be a select number of the modules available. As described above, the activated features are determined by the user account information associated with the user's login information. If the activated features are not all of the modules, then the user may see the inactivated modules in the background (which can appear gray, denoting that such items cannot be selected or used). Or, the inactivated features may be omitted from the background of the hub interface 30. When the user is finished viewing and using the hub interface 30, the user simply closes the browser, which in turn will disconnect the persistent connection between the hub 14 and the user device 12.

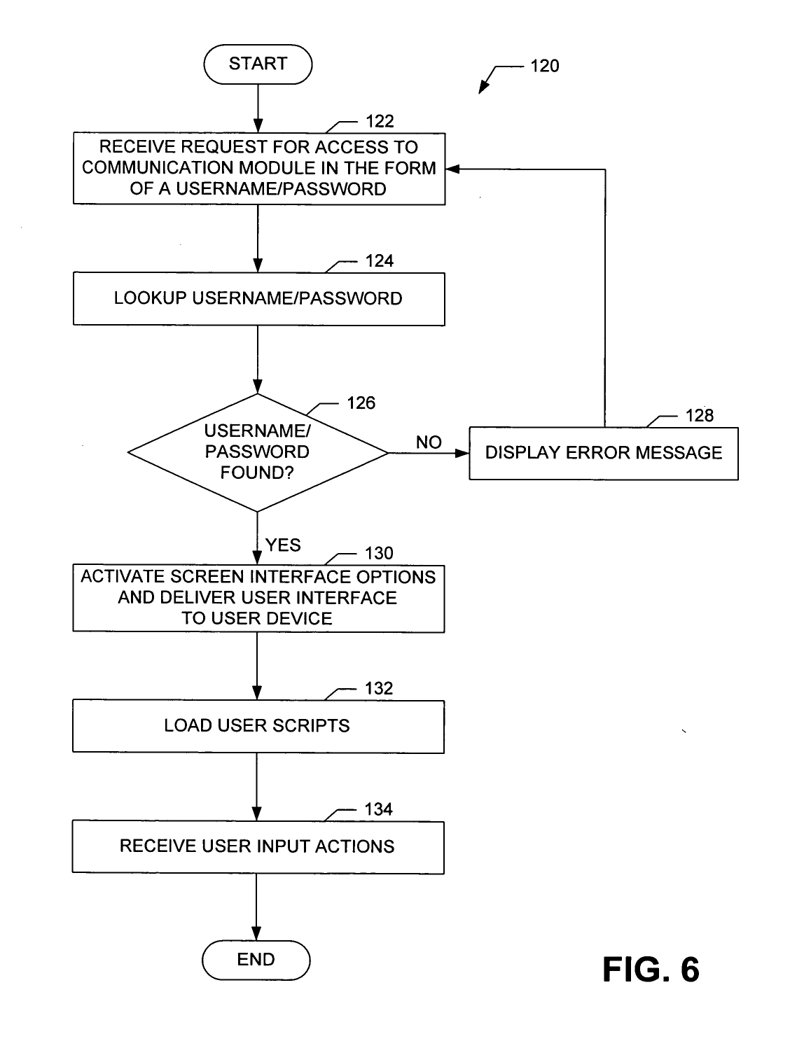

FIG. 6 depicts a method 120 for initiating the hub 14. The method begins at step 122 when the server 18 receives a request for a communication module in the form of login information, such as a username and password. At step 124, the server 18 verifies the login information, typically by using conventional technology such as a look-up table. If the login information cannot be verified, the hub 14 displays an error message to the user at step 128 and prompts the user to reinput login information. The method then returns to step 122. If, however, the login information is verified, the method 120 proceeds to step 130 and activates screen interface options of the hub 14 and delivers the user interface 30 to the user device 12. At step 132, the hub 14 loads the user's scripts including all activated modules for the user's account, and at step 134, the hub 14 receives the user's input regarding the use of the modules. It should be noted that the software or code that runs and controls the activation of the modules, applications, and features is stored on the hub 14, and not on the user device 12, which provides a more secure environment. It should also be noted that, because the hub interface 30 is delivered to the user device 12 with all of the activated modules, applications, and features associated with the user's account, a new and freshly updated interface 30 is delivered to the user device 12 every time the user logs onto the hub 14, which eliminates the need for updates and configurations.

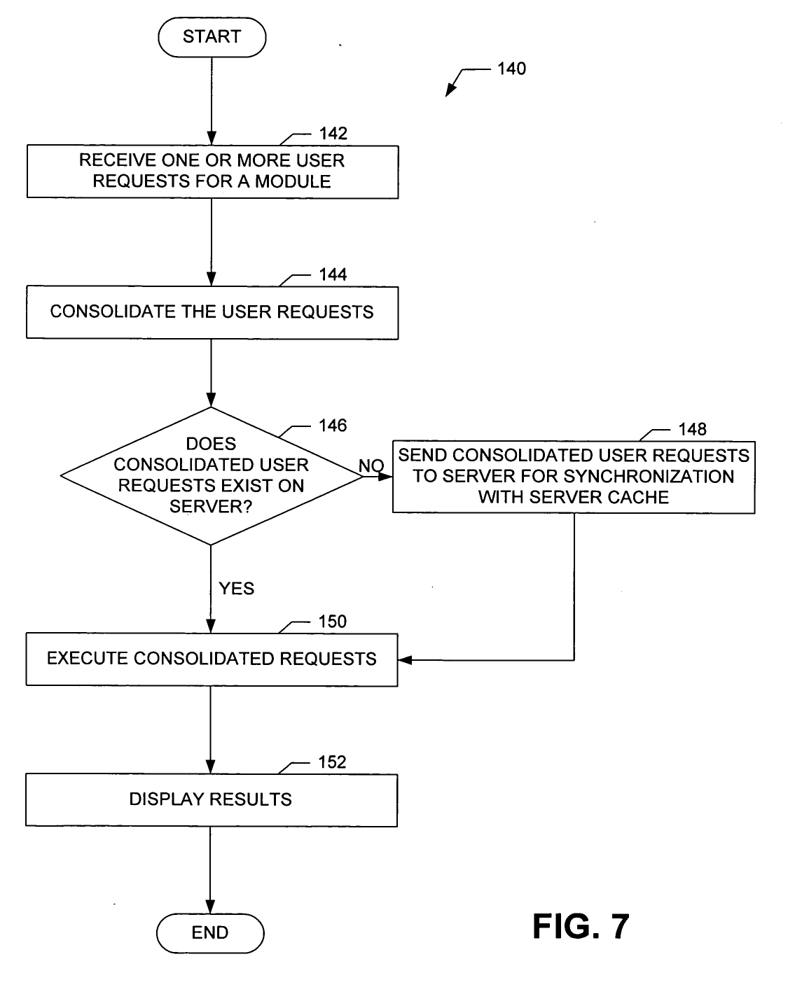

FIG. 7 depicts a method 140 of the invention in accordance with an exemplary embodiment for delivering content from the hub 14 to the user device 12 and for synchronizing cache within the user interface 30 of the user device 12 with the cache on the hub 14. The method 140 begins at step 142 when the hub 14 receives one or more user requests for access to a module (or objection, function, or application). Such requests can come from one or more users. The system 10 consolidates the user requests at step 144. At step 146, the system 10 makes a determination as to whether the consolidated requests currently exist on the server 18. If the consolidated requests do not exist currently exist on the server 18, then the consolidated user requests will be sent to the server 18 at step 148, where the consolidated user requests will be synchronized with the server cache. For example, if a user has uploaded a new document to share with others in the group via a whiteboard, then the server 18 informs the user controls within the hub interface 30 that the file is to be repurposed prior to viewing. Thus, the server 18 sends a command to the user interface 30 that the server 18 is parsing the data of the document. Once the document has been repurposed, the server 18 sends the user a cached instruction code for accessing that document from any user device, including the device currently being used as well as additional devices that may be used in the future, without ever needing to repurpose, reparse or resend lengthy code to the server to access that particular document. Thus, any new event that changes the status of any user interface within a particular group will trigger the server to synchronize its cache with the cache of the user device. Such new events can include, but are not limited to, posting an alert to the system for others to view, passing the control of a module to another user (such as control of a video conference or whiteboard), uploading a new document, and requesting use of a different module.

However, if the consolidated requests do exist, then the cache code of the user interface 30 is sent to the server 18 for check-sum matching, where the server 18 executes the consolidated requests at step 150 and sends back to the user interface 30 and displays the results, which can be the appropriate file, code, or content. Thus, as long as the user status remains the same on the user interface 30, the method does not request synchronization between the server cache and user interface cache. It should be noted that the cache associated with the user interface preferably is not stored on the user device but rather the cache associated with the user interface remains within the user interface so as to provide a more secure connection. Therefore, this method 140 of synchronizing/verifying the cache code of the user interface 30 with cache on the server 18 effectively reduces the overall communication traffic by an order of magnitude and improves the security risks associated with sending data because the hub 14 and the user interface 30 are not constantly sending and receiving requests and commands between each other.

The methods of FIGS. 5, 6, and 7 may be implemented in software, firmware, and/or hardware residing on the hub 14. Typically, the methods are implemented in software or firmware comprising executable instructions for implementing the logical functions. The instructions can be embodied in any suitable computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device.

The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a random access memory (RAM) device, a read-only memory (ROM) device, an erasable programmable read-only memory (EPROM), a Flash memory device, an optical fiber, and a portable compact disk read-only memory (CD ROM). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

Accordingly, it can be seen that the present invention provides a secure system and method for collaborating and communicating data. Advantageously, the present invention provides a system and method, which provide a secure, persistent connection between the hub 14 and the user device 12. The connection is secure because the software or code that controls the modules, features, and applications of the hub interface 30 are stored on the hub 14 itself, and not on the user's device 12 in cache. Thus, the core code for operating each module is stored on the hub 14 and is preferably never entirely within the client application instance, thus securing data and client communications within the server and network.

Moreover, the manner in which the hub 14 processes, stores, and controls the modules of for communication is built upon a database method of controls. Also, once information is streamed to the user device 12, there is no need to reupdate the server 18 to synch the information, as the information is sent to the user device 12 only one time (unless a new event occurs to change the status of the information). This eliminates storing the information on the user device 12. Thus, the system 10 of the present invention is device independent of the hub in the sense that the regardless of the type of user device, the user interface delivered by the hub has the same functionality on every user device (regardless of the type of device). For example, if the user device 12 connected to the hub 14 is a cellular phone, then the session is established and managed by the synchronized cache scheme, described earlier with reference to FIG. 7. Thus, the user requests for content is independent of the device type because of the standardized delivery method of creating the interface 30, along with the controls and content, are supported on the user device as part of the rich media plug-in, which is the ADOBE FLASH PLAYER™ in the exemplary embodiment.

Moreover, unlike conventional systems that require specific ports to be opened on firewalls or applications to be installed on the user device, the hub 14 of the present invention can check for such blocking of services, such as when a firewall blocks certain ports, when the user logins, and then deliver the appropriate server-side services for supporting the type of connection needed, via an alternative method, if desired. Also, the request from the user device 12 to the hub 14 can be sent back from the hub 14 to the user device (which can even be encrypted for higher security) code, data, sync-cache and other relevant information via an encapsulated stream. The stream is unique to the hub 14 and based upon the user information string (including the user's personal information, company or group information, agent information, and product identification information) stored within the database for authorization.

Preferably, all of the modules for the various functions (instant messaging, chat, video conferencing, etc.) associated with the hub interface 30 are delivered to the user device 12 as part of the hub interface 30 so that the user can access the various modules, features, and applications without relogging into the system 10 or passing open keys over the Internet 16. However, those skilled in the art will understand in view of the description provided herein that it is possible to have a separate hub interface associated with each particular module such that each particular hub interface delivers a single module function.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A system for communicating data over a network, comprising:
a user device; and
a server communicatively coupled to user device via the network, wherein the server is configured to receive a request from the user device for access to at least one communication module and to deliver a user interface to the user device to enable the user device to access the communication module, wherein the user interface and the at least one communication module are controlled locally on the user device.

2. The system of claim 1, wherein the at least one communication module includes a plurality of communication modules and wherein the server can selectively activate or deactivate each communication module within the user interface based on the user's access rights.

3. The system of claim 1, wherein the at least one communication module includes one of a video conferencing module, a document management module, and a video-streaming module.

4. The system of claim 3, wherein at least one of the video conferencing module and the document management module includes a whiteboard for sharing files.

5. The system of claim 1, wherein the server is further configured to receive a user document in a first format and to repurpose the user document into a second format.

6. The system of claim 5, wherein the second format is a rich media format.

7. A method for communicating data over a network, comprising:
receiving a request from a user device in a remote server for access to at least one communication module; and
delivering a user interface from the remote server to the user device to enable the user device to access the at least one communication module, wherein the user interface and the at least one communication module are controlled locally on the user device.

8. The method of claim 7, further comprising synchronizing cache on the server with cache associated with the user interface only when a new event within the user interface occurs.

9. The method of claim 8, wherein the new event further includes at least one of posting an alert to the system, passing the control of a module to another user, uploading a new document, and requesting use of a different module.

10. The method of claim 7, further comprising receiving an uploaded document and repurposing the uploaded document prior to publishing the uploaded document for use.

11. The method of claim 10, wherein repurposing the uploaded document further includes repurposing the uploaded document into an interactive format.

12. The method of claim 10, further comprising selectively activating the at least communication module based on a user's access rights.

13. A user interface, comprising:
at least one button or menu for accessing a communication module hosted by a remote server, wherein the communication module is controlled locally on a user device.

14. The user interface of claim 13, wherein the communication module further includes a plurality of communication modules.

15. The user interface of claim 14, wherein the plurality of communication modules includes a video conferencing module, a document management module, and/or a video-streaming module.

16. The user interface of claim 13, wherein the user interface stores cache within the user interface and not on the user device.

17. A computer program for communicating data over a network, the computer program being embodied on a computer-readable medium, the program comprising:
instructions for receiving a request from a user device in a remote server for access to at least one communication module; and
instructions for delivering a user interface to the user device from the remote server, wherein the user interface and the at least one communication module are controlled locally on the user device.

18. The computer program of claim 17, further comprising instructions for synchronizing cache on the server with cache associated with the user interface only when a new event within the user interface occurs.

19. The computer program of claim 17, further comprising instructions for repurposing an uploaded document prior publishing the document for use.

20. The computer program of claim 17, further comprising instructions for selectively activating the at least communication module based on a user's access rights.
